(19) United States
(12) Patent Application Publication
(10) Pub. No.: US 2014/0212566 A1
(43) Pub. Date: Jul. 31, 2014

(54) FROZEN DRINK DISPENSER AND METHOD OF DISPENSING FROZEN DRINKS

(71) Applicant: ISLAND OASIS FROZEN COCKTAIL CO., INC., Walpole, MA (US)

(72) Inventors: John Michael Herbert, Winchester, MA (US); Patrick J. Devine, Nashua, NH (US); John A. MacNeill, Acton, MA (US); Bryan R. Hotaling, Harvard, MA (US)

(21) Appl. No.: 13/754,306

(22) Filed: Jan. 30, 2013

(51) Int. Cl. A47J 31/41; A23G 9/04

(52) U.S. Cl. CPC A47J 31/41; A23G 9/045
USPC 426/590; 99/287; 99/285

(57) ABSTRACT

A frozen drink dispenser includes a housing and a dispensing station supported by the housing and configured to dispense a precise quantity of a flavored fluid from a variety of flavored fluids into a blender cup. The dispensing station includes a first support configured to support the blender cup and weigh contents within the blender cup. The frozen drink dispenser further includes a shaved ice and blend station supported by the housing and configured to dispense a precise quantity of shaved ice within the blender cup and to mix the contents within the blender cup. The shaved ice and blend station includes a second support configured to support the blender cup. The frozen drink dispenser further includes a rinse station configured to rinse and clean the blender cup.

### BACKGROUND OF THE INVENTION

1. Field of the Invention

This invention relates generally to beverage dispensers, and more particularly to a frozen drink beverage dispenser capable of preparing and dispensing a variety of frozen beverages and cleaning a blender cup within a single unit.

2. Description of the Prior Art

Frozen drink dispensers are well known in the art. For example, reference can be made to U.S. Pat. Nos. D427,844, 6,095,677, 6,210,033, 6,216,968, 6,336,603, 6,793,167, and 8,282,268, each of which are assigned to the assignee of the present disclosure.

### SUMMARY OF THE INVENTION

One aspect of the disclosure is directed to a frozen drink dispenser comprising a housing and a dispensing station supported by the housing and configured to dispense a precise quantity of a flavored fluid from a variety of flavored fluids into a blender cup. The dispensing station includes a first support configured to support the blender cup and weigh contents within the blender cup. The frozen drink dispenser further includes a shaved ice and blend station supported by the housing and configured to dispense a precise quantity of shaved ice within the blender cup and to mix the contents within the blender cup. The shaved ice and blend station includes a second support configured to support the blender cup. The frozen drink dispenser further comprises a rinse station configured to rinse and clean the blender cup.

Embodiments of the frozen drink dispenser further include a bottom unit configured to support the housing. In one embodiment, bottom unit includes a refrigeration unit. The dispensing station further includes a pump and a plurality of lines coupled to the pump to deliver flavored fluids to the pump. In one embodiment, the dispensing station further includes a weigh scale. The shaved ice and blend station further includes a chute drive to deposit shaved ice into the blender cup. The shaved ice and blend station further includes a blender drive to drive the operation of blades provided in the blender cup. The frozen drink dispenser further comprises a controller coupled to the pump and the blender drive to control the operation of the frozen drink dispenser. The frozen drink dispenser further comprises a display coupled to the controller. The rinse station includes a nozzle connected to a water supply and a drain. The drain extends from the rinse station to the shaved ice and blend station. The frozen drink dispenser further comprises a transfer mechanism configured to move the blender cup from the dispensing station to the shaved ice and blend station. In one embodiment, the transfer mechanism includes an arm configured to engage a base of the blender cup. The frozen drink dispenser further comprises one or more sensors to detect a presence of the blender cup in the dispensing station and the shaved ice and blend station.

Another aspect of the disclosure is directed to a method of dispensing more than one frozen drinks simultaneously. In one embodiment, the method comprises: dispensing a precise quantity of a flavored fluid from a variety of flavored fluids into a first blender cup from a dispensing station of a frozen drink dispenser; dispensing a precise quantity of shaved ice into a second blender cup and mixing contents in the second blender cup in a shaved ice and blend station of the dispenser; and rinsing a third blender cup in a rinse station of the dispenser. The act of dispensing flavored fluid, dispensing and mixing shaved ice, and rinsing occur substantially simultaneously.

Embodiments of the method further includes weighing the first blender cup after dispensing the precise quantity of the flavored fluid into the first blender cup. In one embodiment, the method further includes blending the contents of the second blender cup with blades provided in the second blender cup. In another embodiment, the method further includes draining excess from the shaved ice and blend station and the rinse station in a common drain that extends from the rinse station to the shaved ice and blend station. In another embodiment, the method further includes controlling the operation of the dispenser with a controller and displaying user operational commands on a display.

### BRIEF DESCRIPTION OF THE DRAWINGS

FIGS. 1 and 2 are perspective views of a frozen drink dispenser of an embodiment of the present disclosure;

FIG. 3 is a schematic representation of the frozen drink dispenser shown in FIGS. 1 and 2;

FIG. 4 is an enlarged perspective view of an upper unit of a frozen drink dispenser of another embodiment of the present disclosure;

FIG. 5 is a front view thereof;

FIG. 6 is a rear view thereof;

FIG. 7 is a right-side elevational view thereof;

FIG. 8 is a left-side elevational view thereof;

FIG. 9 is a top plan view thereof;

FIG. 10 is a bottom plan view thereof;

FIG. 11-13 are perspective views of the upper unit of the frozen drink dispenser shown in FIGS. 4-10 with portions removed to illustrate internal components of the frozen drink dispenser; and

FIG. 14 is a schematic representation of the frozen drink dispenser shown in FIGS. 4-13.

### DETAILED DESCRIPTION OF PREFERRED EMBODIMENTS

For the purposes of illustration only, and not to limit the generality, the present invention will now be described in detail with reference to the accompanying figures. This invention is not limited in its application to the details of construction and the arrangement of components set forth in the following description or illustrated in the drawings. The invention is capable of other embodiments and of being practiced or being carried out in various ways. Also the phraseology and terminology used herein is for the purpose of description and should not be regarded as limiting. The use of “including,” “comprising,” “having,” “containing” “involving,” and variations thereof herein, is meant to encompass the items listed thereafter and equivalents thereof as well as additional items.

The present disclosure is directed to a dispenser, particularly, a frozen drink dispenser, which is capable of performing multiple functions simultaneously. In one embodiment, the frozen drink dispenser includes a top unit that rests upon a bottom unit. The top unit includes a dispensing station, a shaved ice and blend station and a rinse station, all of which are supported by a common housing. The dispensing station is configured to dispense a precise quantity of a flavored fluid from a variety of flavored fluids into a blender cup. The dispensing station includes a dispenser and a support that is configured to support the blender cup and weigh contents dispensed within the blender cup. The shaved ice and blend station is configured to dispense a precise quantity of shaved ice within the blender cup and to mix the contents within the blender cup. The shaved ice and blend station includes a shaved ice and blend dispenser and a support that is configured to support the blender cup. The rinse station is configured to rinse and clean the blender cup.

The arrangement is such that an operator of the dispenser can initiate a dispensing operation within the dispensing station, a dispense and mix operation within the shaved ice and blend station, and a rinsing operation within the rinse station substantially simultaneously. Thus, the operator of the dispenser can produce frozen drinks more quickly and efficiently than prior art dispensers.

Dispensing of flavoring product into a blender cup in a position that is different from a position where ice is dispensed into the blender cup can provide numerous advantages. For example, if the position where the ice is dispensed is different than the position where the flavored product is dispensed, a larger ice chute may be provided than if the ice chute had to share a position with flavoring product dispensers. Embodiments having larger ice chutes may exhibit a greater rate of ice dispensation, lowering a cycle time for the preparation of a frozen drink, as compared to conventional systems with smaller ice chutes. Further, in embodiments where flavoring product dispensers are located in a different position than an ice dispenser, a greater number and variety of flavoring dispensers may be provided. This allows for such a system to be capable of preparing a greater variety of frozen drinks as compared to a system where the number and/or type of flavoring dispensers are limited due to concerns with blocking the dispensing of ice from an ice dispenser.

Further, in embodiments in which a blender cup is placed on a moveable platform for the preparation of frozen drinks, or in embodiments in which the blender cup is moved to different positions on a stationary platform during the preparation of a frozen drink, the platform or the blender cup may be moved into a position where the top of the blender cup is at least partially unobstructed by flavoring dispensers or an ice dispenser. This may provide for a greater ease of manually introducing products, such as solid fruit or additional liquid product, into the blender cup as compared to conventional systems in which the blender cup is placed in a position below an ice dispenser and/or flavoring product dispenser(s).

Some embodiments of the present disclosure include a weight sensor coupled to the platform on which the blender cup is supported. The weight sensor is used to monitor the changing weight of the blender cup as product is added to the blender cup. This provides for a method of dispensing a known quantity of flavoring product by weight. Dispensing flavoring product by weight may provide for a more accurate dispensed amount of ingredients than in systems wherein the flavoring product is dispensed for a defined time.

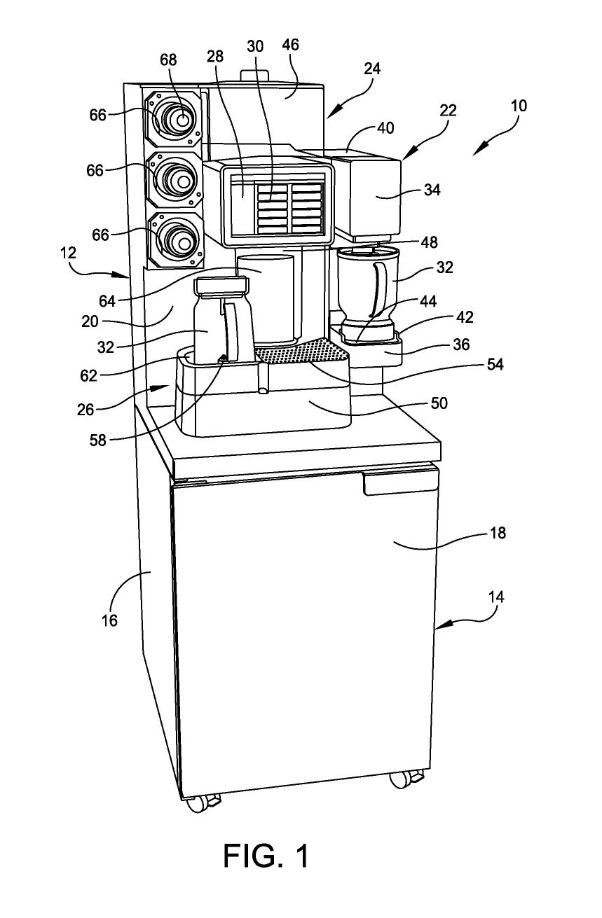

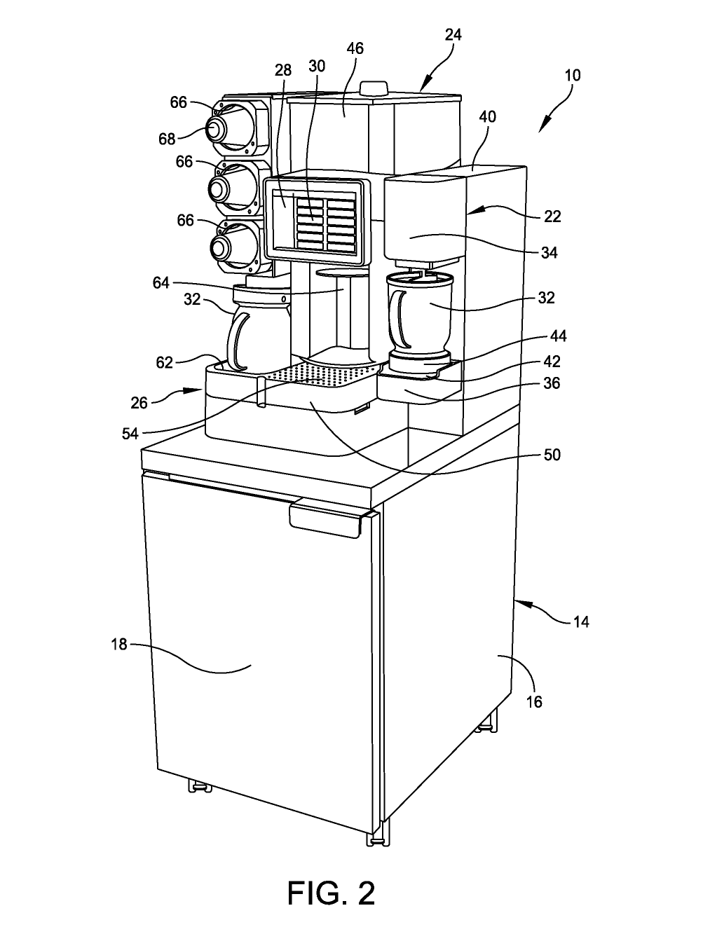

Referring to the drawings, and more particularly to FIGS. 1 and 2, there is generally indicated at 10 a frozen drink dispenser of a first embodiment of the present disclosure. The dispenser 10 includes a top unit, generally indicated at 12, and a bottom unit, generally indicated at 14. The top unit 12 houses the working components of the dispenser 10 used to produce frozen beverages. In one embodiment, the bottom unit 14 may include a refrigeration unit configured to house beverage fluids and to deliver such fluids to the operating components of the dispenser. The bottom unit 14 may include a thermally insulated compartment 16 and a heat pump (not shown) to cool the interior of the compartment. The bottom unit 14 may further include a front door 18 to access the interior of the compartment 16. As mentioned, the bottom unit 14 is configured to store quantities of beverage fluids, such as flavors used to produce frozen beverages. The flavors may be stored in containers that are connected to the top unit 12 of the dispenser 10 by one or more lines (e.g., tubes), which will be described in greater detail below. Depending on the size of the containers, up to 32 containers may be stored in the bottom unit 14 of the dispenser 10. This configuration enables the dispenser 10 to provide many flavor options to consumers of frozen drinks.

The top unit 12 of the dispenser 10 includes a housing 20 that is configured to support three primary stations—a dispensing station generally indicated at 22, a shaved ice and blend station generally indicated at 24, and a rinse station generally indicated at 26. The dispenser 10 further includes a controller 28, which is provided to control the operation of the dispenser, and a display 30, which enables an operator to manipulate the operation of the dispenser. The arrangement is such that an operator through the display 30 may simultaneously dispense a quantity of fluid into a blender cup 32 from the dispensing station 22, dispense a quantity of shaved ice into a separate blender cup (not shown in FIGS. 1 and 2) and mix the shaved ice and the dispensed fluid in the shaved ice and blend station 24, and rinse yet another blender cup 32 in the rinse station 26. The construction of the dispenser 10 improves cycle time and enables an operator to produce frozen beverages more quickly and efficiently.

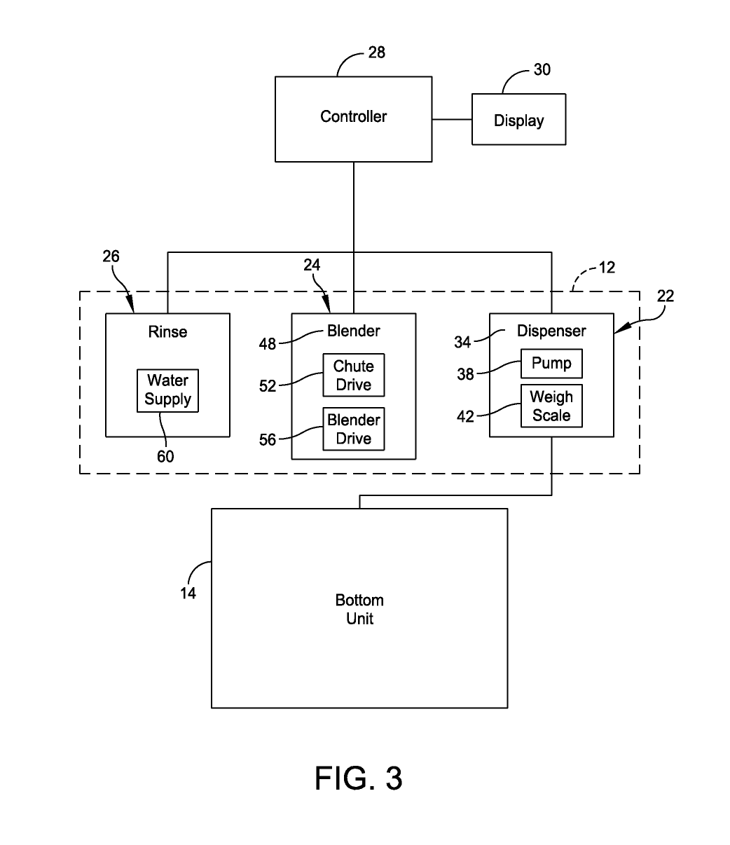

As shown, the dispensing station 22 includes a flavor dispensing unit 34 and a first support 36 positioned below the flavor dispensing unit. In the embodiment shown in FIGS. 1 and 2, the dispensing station 22 is located on the right-hand side of the top unit 12 in which the blender cup 32 may be positioned on the first support 36 with the flavor dispensing unit 34 being disposed above the blender cup. With reference to FIG. 3, the flavor dispensing unit 34 of the dispensing station 22 further includes a pump 38 and a plurality of lines coupled to the pump to deliver flavored fluids to the pump. Specifically, the lines may be provided from the containers located within the bottom unit 14 and the pump 38 provided in a casing 40 of the flavor dispensing unit 34. The flavor dispensing unit 34 of the dispensing station 22 may include more than one pump depending on the requirements of the particular dispenser. For example, in a situation in which more than one flavor is to be dispensed, the flavor dispensing unit 34 may include two or more pumps to achieve simultaneous dispensing of such flavors.

The first support 36 of the dispensing station 22 further includes a weigh scale 42 that is incorporated within a drain 44 to weigh the contents of the flavors dispensed into the blender cup 32. During operation, an operator selects a particular flavor or flavors to dispense on the display 30. The flavor is dispensed by the flavor dispensing unit 34 until a predetermined amount is deposited in the blender cup 32. The weigh scale 42 communicates with the controller 28, which in turn communicates with the flavor dispensing unit 34 to cease the operation of the flavor dispensing unit once the predetermined amount of flavor is dispensed in the blender cup 32. Thus, accurate dispensing of the flavor into the blender cup 32 may be achieved prior to dispensing shaved ice into the blender cup. The first support 36 of the dispensing station 22 is configured to contain overflow flavors and to be releasably secured the housing 20 to enable an operator to remove the first support for cleaning. In another embodiment, the first support 36 may be configured to drain overflow flavors into a common drain provided between the dispensing station 22 and the shaved ice and blend station 24 and the rinse station 26.

As mentioned above, the shaved ice and blend station 24 is configured to dispense a precise quantity of shaved ice within the blender cup 32 and to mix or blend the contents within the blender cup. The shaved ice and blend station 24 is positioned next to the dispensing station 22 and includes a container 46 for storing ice, a shaved ice and blend dispensing unit 48, and a second support 50 positioned below the shaved ice and blend dispensing unit. The container 46 may be fabricated from see-through (transparent or translucent) plastic so that the operator can visually inspect how much ice is stored therein. The shaved ice and blend dispensing unit 48 is coupled to the controller 28 and operates in the well known manner. The shaved ice and blend dispensing unit 48 of the shaved ice and blend station 24 is configured with a chute drive 52 (e.g., an auger screw device) that is configured to dispense a precise amount of shaved ice into the blender cup 32 by rotating a predetermined number of times. The arrangement is such that by rotating the auger screw device of the chute drive 52 of the shaved ice and blend dispensing unit 48 a predetermined number of times a known quantity of shaved ice is dispensed. The controller 28 may be programmed to dispense a known amount of shaved ice into the blender cup 32 depending on the type of frozen drink being prepared.

The second support 50 of the shaved ice and blend station 24 is configured to support the blender cup 32 when dispensing shaved ice into the blender cup. The second support includes a drain 54 configured to collect overflow material or material that is inadvertently dispensed outside the blender cup 32. In certain embodiments, the second support 50 of the dispensing station 24 may include a weigh scale that is incorporated within the drain to weigh the contents of the shaved ice and flavors dispensed into the blender cup. However, in the shown embodiment, the second support 50 does not include such a weigh scale. During operation, an operator places the blender cup 32 under the shaved ice and blend dispensing unit 48 of the shaved ice and blend station 24 and initiates the dispensing of shaved ice in the blender cup. The shaved ice is dispensed by the shaved ice and blend dispensing unit 48 until a predetermined amount of shaved ice is deposited in the blender cup 32. The shaved ice and blend station 24 further includes a blender drive 56 to drive the operation of blades provided in the blender cup. In one embodiment, the blender drive 56 may include a magnet drive to drive the rotation of the blades of the blender cup, such as the magnet drive disclosed in U.S. Pat. No. 8,282,268, which is assigned to the assignee of the present disclosure. In another embodiment, the blender drive 56 may include a rotor drive arrangement. The blender drive 56 blends the contents of the blender cup 32 to produce a homogenous frozen beverage.

The rinse station 26 is positioned next to the shaved ice and blend station 24 on the left-hand side of the top unit 12 as shown in FIGS. 1 and 2. The rinse station 26 is configured to rinse and clean the blender cup 32. Specifically, the rinse station 26 includes a nozzle 58 connected to a water supply 60 and a drain 62. The nozzle 58 is configured to spray water on the blender cup 32 when the blender cup is positioned over the nozzle 58 in an inverted manner, which is illustrated in FIGS. 1 and 2. In a certain embodiment, the drain 62 extends from the rinse station 26 to the shaved ice and blend station 24. In one embodiment, the common drain formed by drain 44 of the shaved ice and blend station 24 and the drain 62 of the rinse station 26 leads to a drain line (not shown) provided at the back of the housing 20 of the dispenser 10 to a drain associated with the existing infrastructure. In another embodiment, the drain can be removed for dispensing and cleaning.

As shown in FIGS. 1 and 2, the display 30 is provided above a receptacle 64 of the shaved ice and blend station 24 that is configured to receive the blender cup 32. The controller 28 is located behind the display 30, and embodies a printed circuit board configured to control the operation of the dispenser 10. With reference to FIG. 3, the controller 28 is coupled to the pump 38 and the weigh scale 42 of the dispensing unit 22 and the chute drive 52 and the blender drive 56 of the shaved ice and blend dispensing unit 24 to control the operation of the frozen drink dispenser 10. In one embodiment, the controller 28 is further coupled to a valve (not shown) of the water supply 60 of the rinse station 26 to control the amount of water flowing through the nozzle 58 to rinse used blender cup. In another embodiment, the rinse station is a standalone unit having a sensor to detect the presence of a blender cup to open the valve to perform a rinse operation. An operator of the dispenser 10 initiates dispensing of flavors and ice and rinsing of a used blender cup 32 through the display 30, which coupled to the controller 28. The display 30 is provided with a graphic user interface that provides an easy-to-use menu for the operator to control the operation of the dispenser 10.

The dispenser 10 further includes several receptacles, each indicated at 66, which are designed to receive disposable cups 68. The operator may pour a blended frozen drink into the disposable cup 68 after preparing the drink.

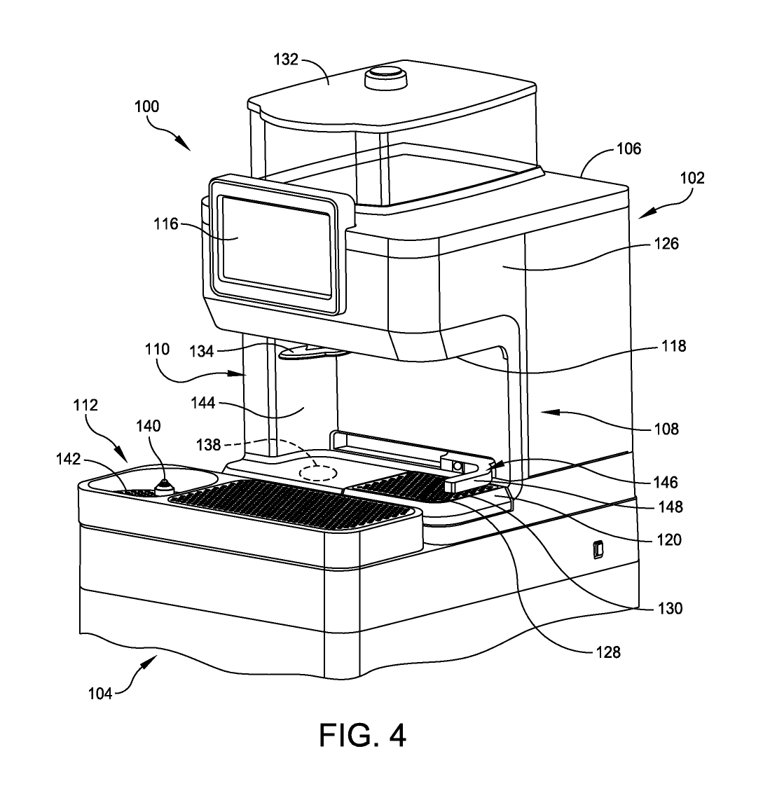

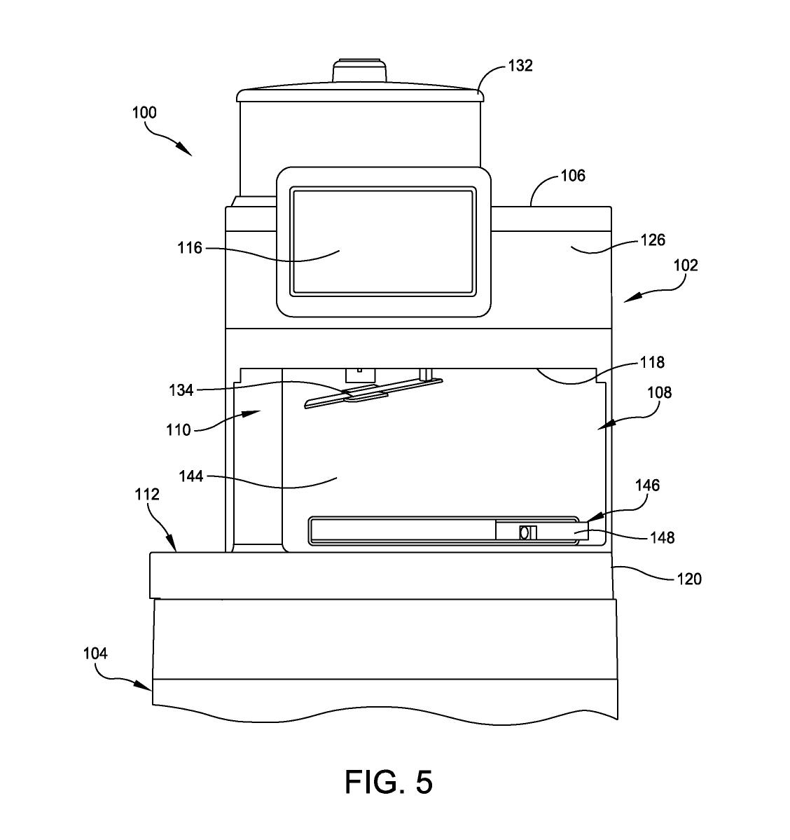

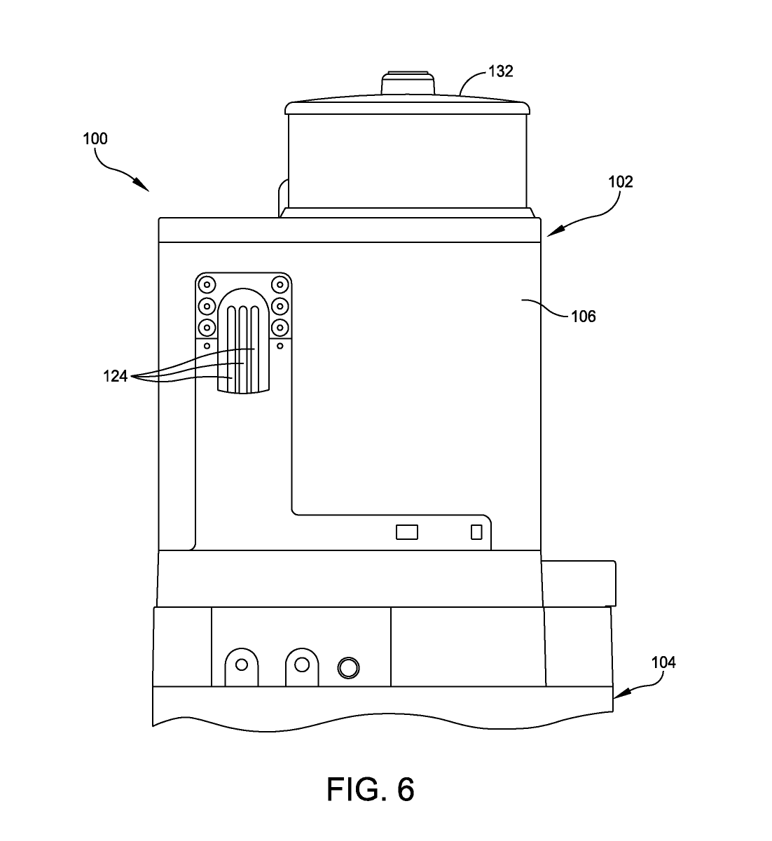

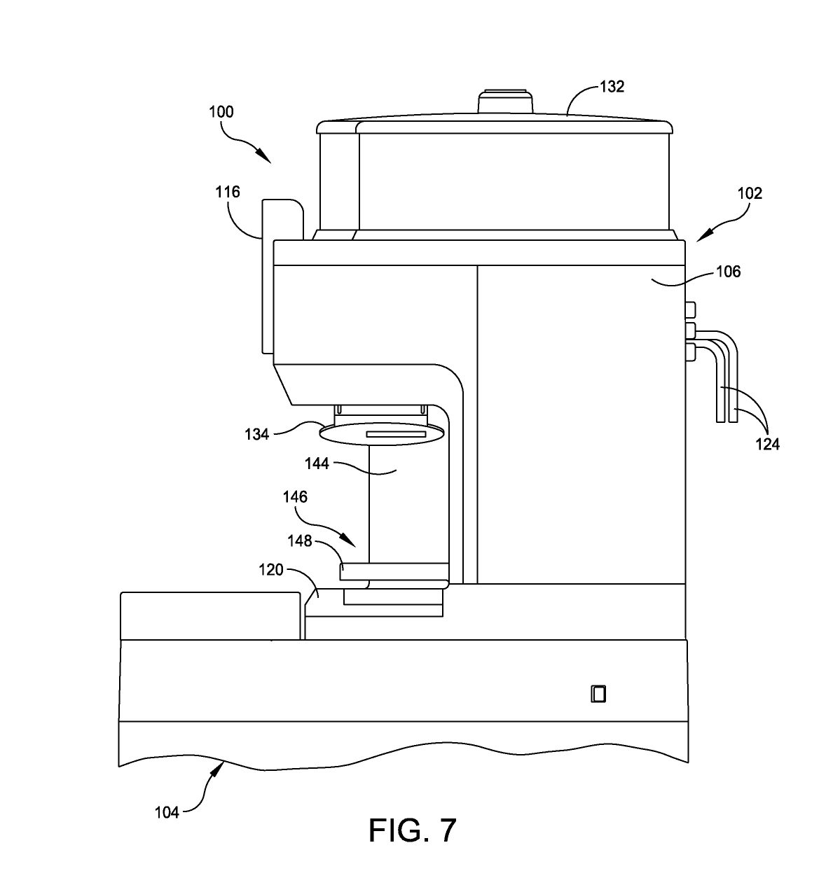

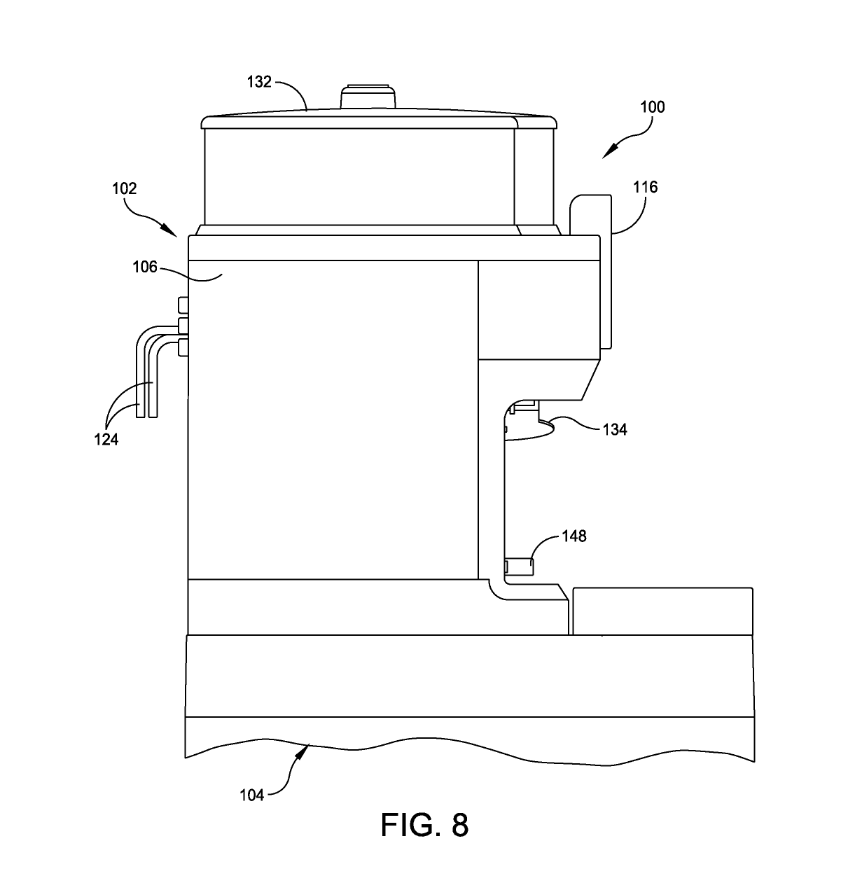

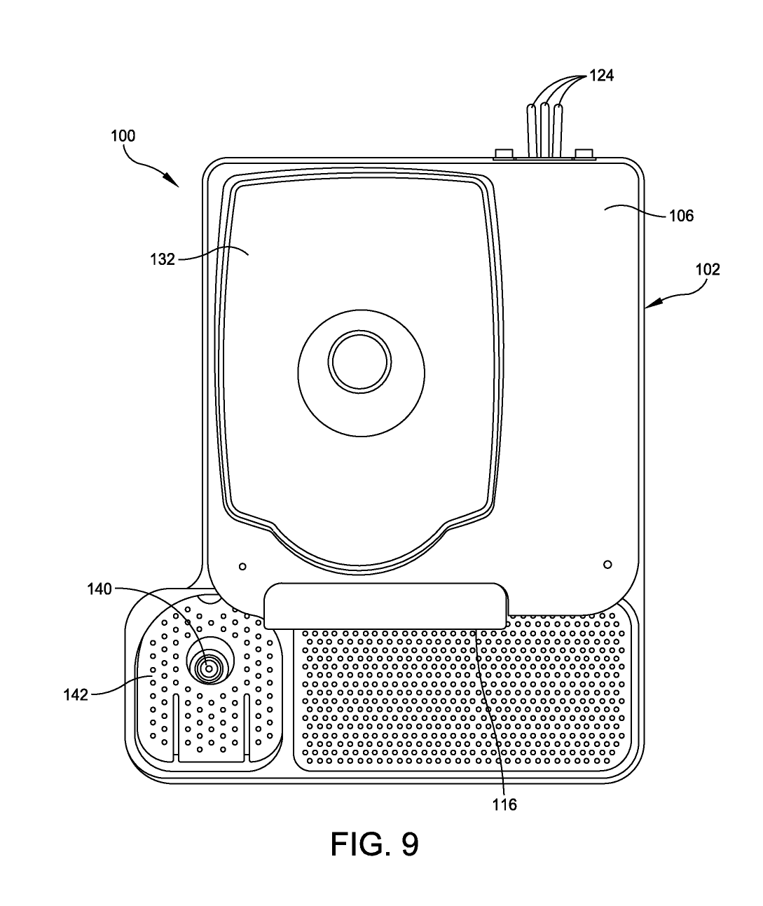

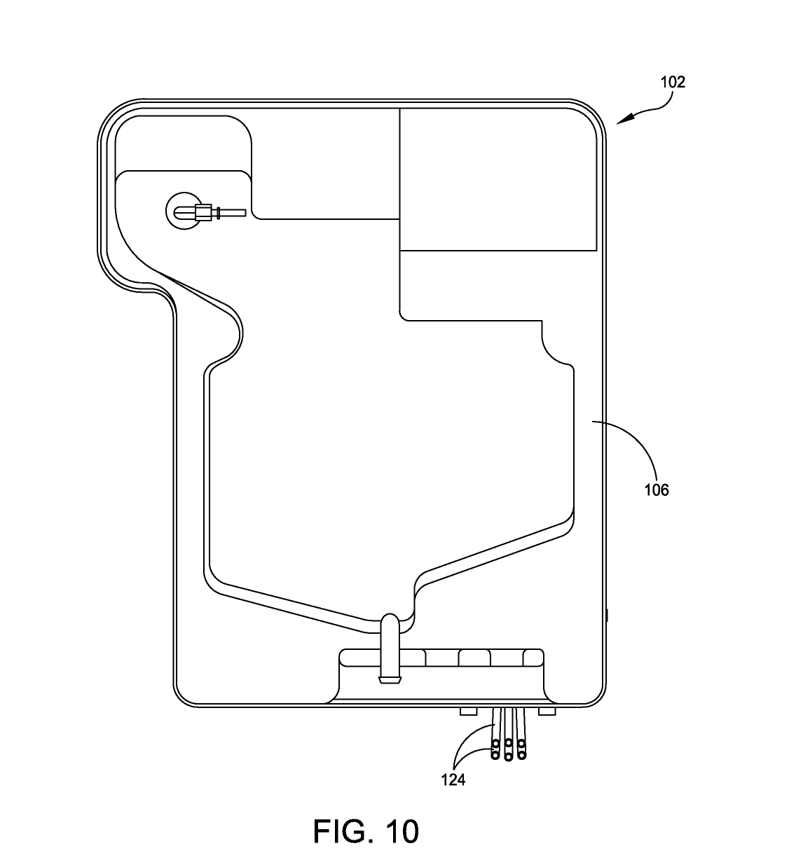

Referring to FIGS. 4-10 and 14, in another embodiment, a dispenser is generally indicated at 100. As shown, the dispenser 100 includes a top unit, generally indicated at 102, and a portion of a bottom unit, generally indicated at 104. As with dispenser 10, the top unit 102 of dispenser 100 houses the working components of the dispenser 100 used to produce frozen beverages. The bottom unit 104 is constructed similarly (if not identically) as the bottom unit 14 of dispenser 10. The top unit 102 of the dispenser 100 includes a housing 106 that is configured to support three primary stations—a dispensing station generally indicated at 108, a shaved ice and blend station generally indicated at 110, and a rinse station generally indicated at 112. The dispenser 100 further includes a controller 114, which is provided to control the operation of the dispenser, and a display 116, which enables an operator to manipulate the operation of the dispenser. As with dispenser 10, the dispenser 100 is capable of enabling an operator through the display 116 to simultaneously dispense a quantity of fluid into a blender cup (not shown but similar to blender cup 32) from the dispensing station 108, dispense a quantity of shaved ice into a separate blender cup and mix the shaved ice and the dispensed fluid in the shaved ice and blend station 110, and rinse yet another blender cup in the rinse station 112. The construction of the dispenser 100 improves cycle time and enables an operator to produce frozen beverages more quickly and efficiently.

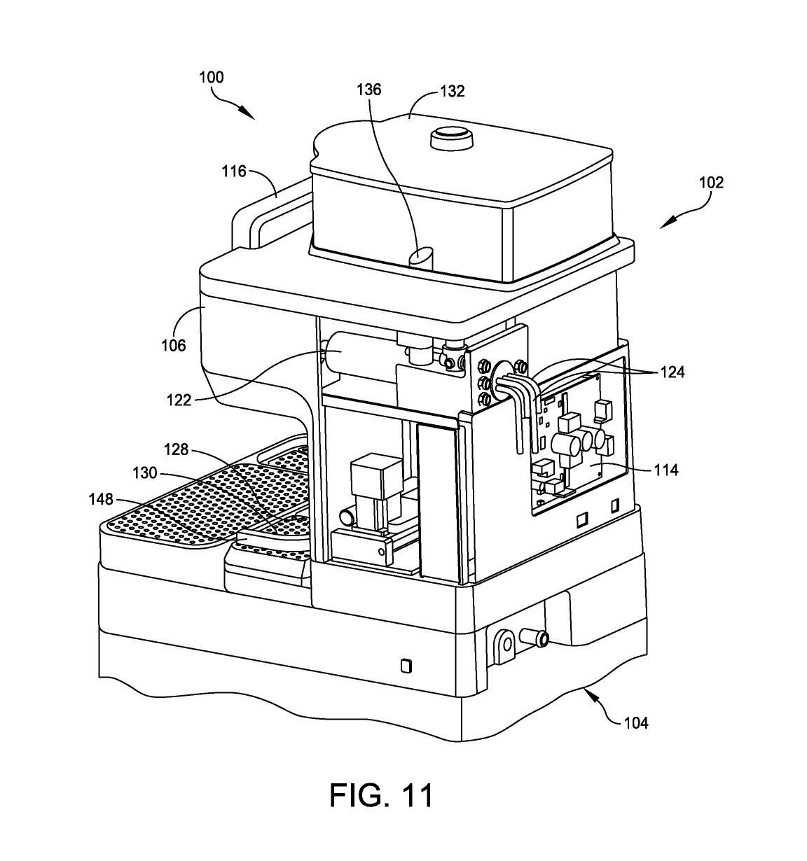

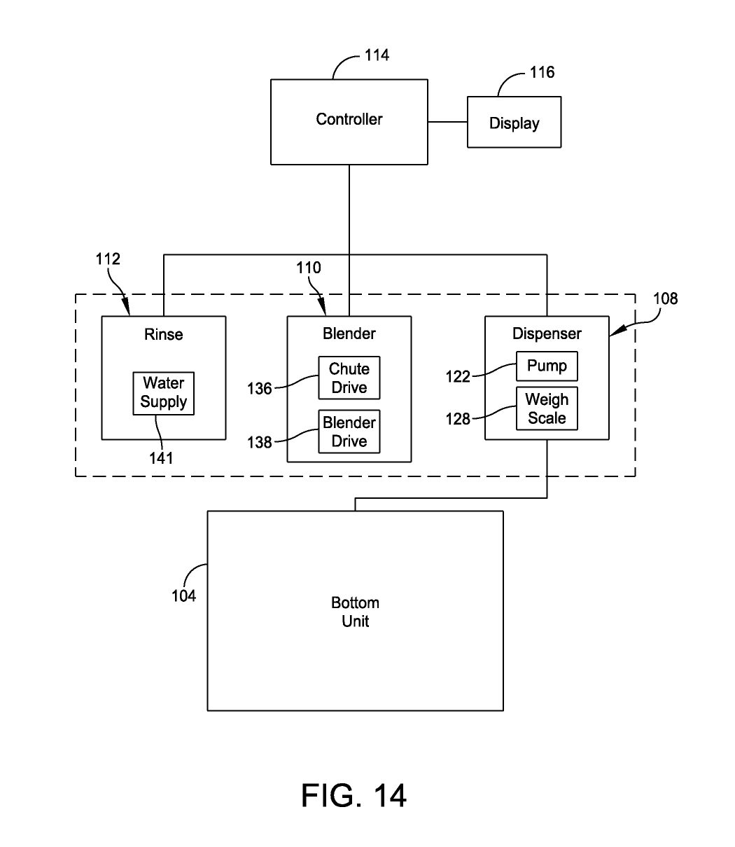

As shown, the dispensing station 108 includes a flavor dispensing unit 118 and a support 120 positioned below the flavor dispensing unit. As with dispenser 10, the dispensing station 108 of the dispenser 100 is located on the right-hand side of the top unit 102 in which a blender cup may be positioned on the support 120 with the flavor dispensing unit 118 being disposed above the blender cup. With reference to FIGS. 11 and 14, the flavor dispensing unit 118 of the dispensing station 108 further includes a pump 122 and a plurality of lines, each indicated at 124, coupled to the pump to deliver flavored fluids to the pump. Specifically, the lines 124 may be provided from the containers located within the bottom unit 104 and the pump 122 provided in a casing 126 of the flavor dispensing unit 118. The flavor dispensing unit 118 of the dispensing station 108 may include more than one pump depending on the requirements of the particular dispenser. For example, in a situation in which more than one flavor is to be dispensed, the flavor dispensing unit 118 may include two or more pumps to achieve simultaneous dispensing of such flavors.

The support 120 of the dispensing station 108 further includes a weigh scale 128 that is incorporated within a drain 130 to weigh the contents of the flavors dispensed into the blender cup. During operation, an operator selects a particular flavor or flavors to dispense on the display 116 of the dispenser 100. The flavor is dispensed by the flavor dispensing unit 118 until a predetermined amount is deposited in the blender cup. The weigh scale 128 communicates with the controller 114, which in turn communicates with the flavor dispensing unit 118 to cease the operation of the flavor dispensing unit once the predetermined amount of flavor is dispensed in the blender cup. Thus, accurate dispensing of the flavor into the blender cup may be achieved prior to dispensing shaved ice into the blender cup. The support 120 is configured to drain overflow flavors into the common drain 130 provided between the dispensing station 108 and the shaved ice and blend and rinse stations 110, 112.

As mentioned above, the shaved ice and blend station 110 is configured to dispense a precise quantity of shaved ice within the blender cup and to mix the contents within the blender cup. The shaved ice and blend station 110 is positioned next to the flavor dispensing unit 118 and includes a container 132 for storing ice and a shaved ice and blend dispensing unit 134. As shown, the support 120 extends from the dispensing station 108 to the shaved ice and blend station 110. The container 132 may be fabricated from see-through (transparent or translucent) plastic so that the operator can visually inspect how much ice is stored therein. The shaved ice and blend dispensing unit 134 is coupled to the controller 114 and operates in the well known manner. The shaved ice and blend station 110 is configured with a chute drive 136 (e.g., an auger screw device) that is configured to dispense a precise amount of shaved ice into the blender cup by rotating a predetermined number of times. As with dispenser 10, the dispenser 100 operates by rotating the auger screw device of the chute drive 136 of the shaved ice and blend dispensing unit 134 a predetermined number of times to dispense a known quantity of shaved ice is dispensed.

The support 120 of the shaved ice and blend station 110 is configured to support the blender cup when dispensing shaved ice into the blender cup. During operation, an operator places the blender cup under the shaved ice and blend dispensing unit 134 and initiates the dispensing of shaved ice in the blender cup. The shaved ice is dispensed by the shaved ice and blend dispensing unit 134 until a predetermined amount of shaved ice is deposited in the blender cup. The shaved ice and blend station 110 further includes a blender drive 138 to drive the operation of blades provided in the blender cup. In one embodiment, the blender drive 138 may include a magnet drive to drive the rotation of the blades of the blender cup, such as the magnet drive disclosed in U.S. Pat. No. 8,282,268, which is assigned to the assignee of the present disclosure. In another embodiment, the blender drive 138 may include a rotor drive arrangement. The blender drive 138 blends the contents of the blender cup to produce a homogenous frozen beverage. The drain 130 provided in the support 120 is configured to drain excess material that may be spilled from performing a dispense operation to drain defined by the rinse station.

The rinse station 112 is positioned adjacent to the shaved ice and blend station 110 on the left-hand side of the top unit 102 and forward of the dispensing and shaved ice and blend stations 108, 110. The rinse station 112 is configured to rinse and clean the blender cup. Specifically, the rinse station includes a nozzle 140 connected to a water supply 141 and a drain 142. The nozzle 140 is configured to spray water on the blender cup when the blender cup is positioned over the nozzle in an inverted manner. In a certain embodiment, the drain 142 extends from the rinse station 112 to the shaved ice and blend station 110. The common drain 142 leads to a drain line (not shown) provided at the back of the housing 106 of the dispenser 100 to a drain associated with the existing infrastructure.

As shown in FIGS. 11-14, the display 116 is provided above a receptacle 144 of the shaved ice and blend station 110 that is configured to receive the blender cup. The controller 114 is located behind the display 116, and embodies a printed circuit board configured to control the operation of the dispenser 100. The controller 114 is coupled to the pump 122 and the weigh scale 128 of the flavor dispensing unit 118 and the chute drive 136 and the blender drive 138 of the shaved ice and blend dispensing unit 134 to control the operation of the frozen drink dispenser 100. In one embodiment, the controller 114 is further coupled to a valve of the water supply 141 of the rinse station 112 to control the amount of water flowing through the nozzle 140 to rinse used blender cup. In another embodiment, the rinse station is a standalone unit having a sensor to detect the presence of a blender cup to open the valve to perform a rinse operation. An operator of the dispenser 100 initiates dispensing of flavors and ice and rinsing of a used blender cup through the display 116, which coupled to the controller 114. The display 116 is provided with a graphic user interface that provides an easy-to-use menu for the operator to control the operation of the dispenser 100.

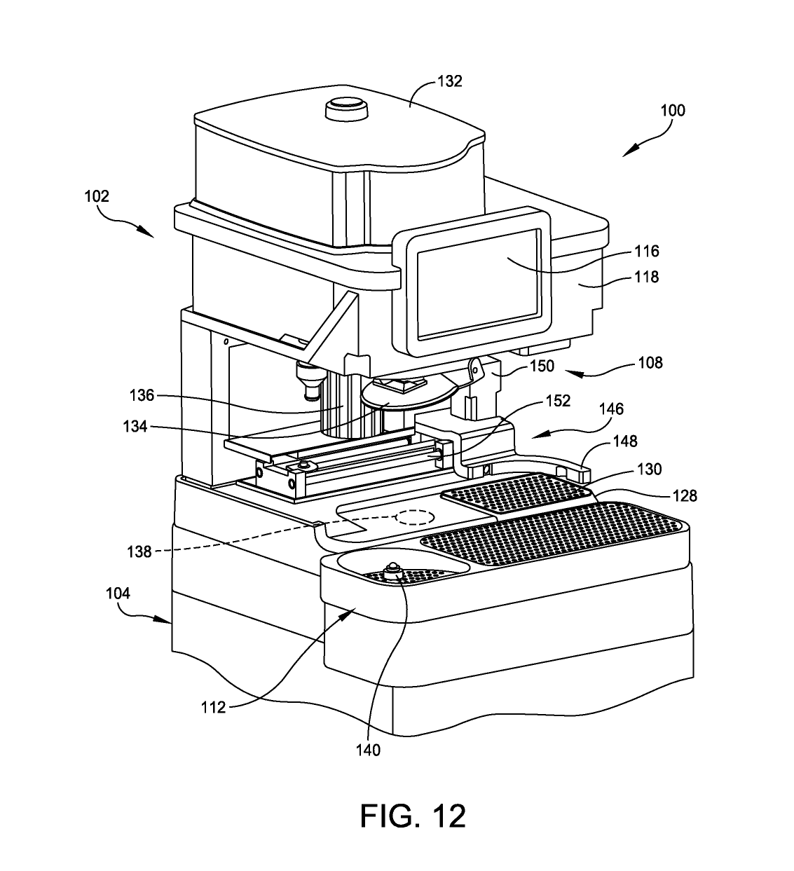

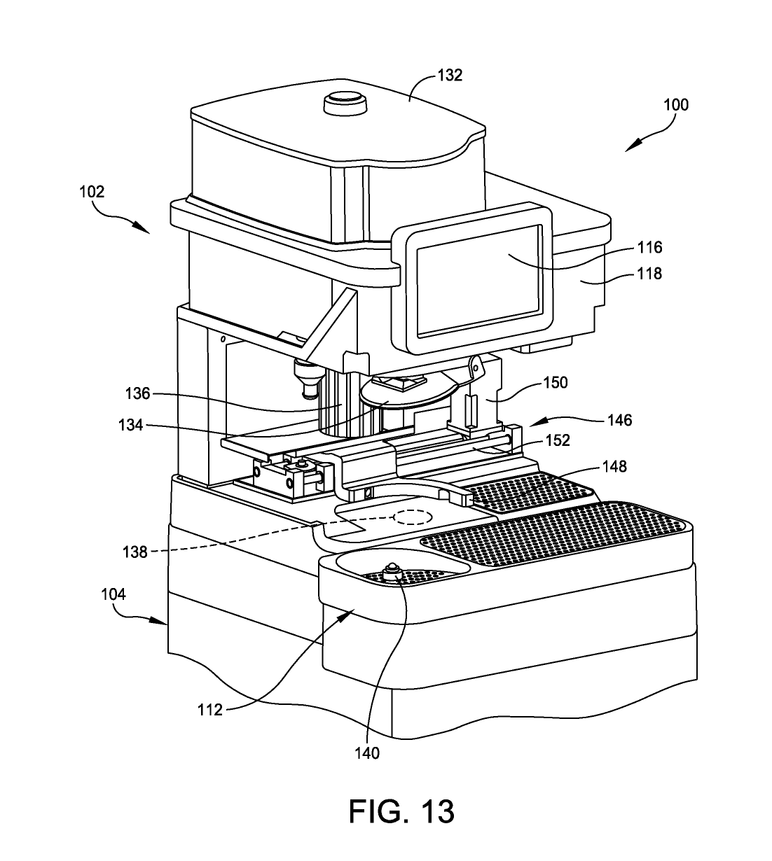

The dispenser 100 shown in FIGS. 4-14 may further include a transfer mechanism, generally indicated at 146, which is configured to move the blender cup from the dispensing station 108 to the shaved ice and blend station 110. As shown, the transfer mechanism 146 includes an arm 148 configured to engage a base of the blender cup to move the blender cup from the dispensing station 108 to the shaved ice and blend station 110. The arm 148 is connected to a motor 150 connected to a drive screw 152 to move the arm from the dispensing station 108 (FIG. 12) to the shaved ice and blend station 110 (FIG. 13). In another embodiment, the dispenser 100 includes one or more sensors, coupled to the controller 114, to detect a presence of the blender cup in the dispensing station 108 and the shaved ice and blend station 110.

It should be observed that the frozen drink dispenser of the embodiments disclosed herein is capable of performing simultaneous operations within the dispenser. For example, a method disclosed herein includes simultaneously dispensing flavors into a blender cup, dispensing shaved ice into another blender cup, and rinsing yet another blender cup. Specifically, the method includes dispensing a precise quantity of a flavored fluid from a variety of flavored fluids into a first blender cup from a dispensing station of a frozen drink dispenser. The method further includes dispensing a precise quantity of shaved ice into a second blender cup and mixing contents in the second blender cup in a shaved ice and blend station of the dispenser. And finally, the method further includes rinsing a third blender cup in a rinse station of the dispenser. With this method, the dispensing of flavored fluid, dispensing of shaved ice, and rinsing occur substantially simultaneously. The method further includes weighing the first blender cup after dispensing the precise quantity of the flavored fluid into the first blender cup. The method further includes weighing the second blender cup after dispensing the precise quantity of shaved ice into the second blender cup. The method may include blending the contents of the second blender cup with blades provided in the second blender cup. The method further includes draining excess from the dispensing station. In one embodiment, the shaved ice and blend station and the rinse station in a common drain that extends from the rinse station to the shaved ice and blend station and to the dispensing station. The methods discussed herein may be controlled by the controller in which user operational commands are displayed on a display.

Having thus described at least one embodiment of the present disclosure, various alternations, modifications and improvements will readily occur to those skilled in the art. Such alterations, modifications and improvements are intended to be within the scope and spirit of the disclosure. Accordingly, the foregoing description is by way of example only and is not intended to be limiting. The disclosure's limit is defined only in the following claims and equivalents thereto.

What is claimed is:

1. A frozen drink dispenser comprising:
a housing;
a dispensing station supported by the housing and configured to dispense a precise quantity of a flavored fluid from a variety of flavored fluids into a blender cup, the dispensing station including a first support configured to support the blender cup and weigh contents within the blender cup;
a shaved ice and blend station supported by the housing and configured to dispense a precise quantity of shaved ice within the blender cup and to mix the contents within the blender cup, the shaved ice and blend station including a second support configured to support the blender cup; and
a rinse station configured to rinse and clean the blender cup.

2. The frozen drink dispenser of claim 1, wherein the dispensing station further includes a pump and a plurality of lines coupled to the pump to deliver flavored fluids to the pump.

3. The frozen drink dispenser of claim 2, wherein the dispensing station further includes a weigh scale.

4. The frozen drink dispenser of claim 2, wherein the shaved ice and blend station further includes a chute drive to deposit shaved ice into the blender cup.

5. The frozen drink dispenser of claim 4, wherein the shaved ice and blend station further includes a blender drive to drive the operation of blades provided in the blender cup.

6. The frozen drink dispenser of claim 5, further comprising a controller coupled to the pump and the blender drive to control the operation of the frozen drink dispenser.

7. The frozen drink dispenser of claim 6, further comprising a display coupled to the controller.

8. The frozen drink dispenser of claim 1, wherein the rinse station includes a nozzle connected to a water supply and a drain.

9. The frozen drink dispenser of claim 8, wherein the drain extends from the rinse station to the shaved ice and blend station.

10. The frozen drink dispenser of claim 1, further comprising a bottom unit configured to support the housing.

11. The frozen drink dispenser of claim 10, wherein the bottom unit includes a refrigeration unit.

12. The frozen drink dispenser of claim 1, further comprising a transfer mechanism configured to move the blender cup from the dispensing station to the shaved ice and blend station.

13. The frozen drink dispenser of claim 12, wherein the transfer mechanism includes an arm configured to engage a base of the blender cup.

14. The frozen drink dispenser of claim 12, further comprising one or more sensors to detect a presence of the blender cup in the dispensing station and the shaved ice and blend station.

15. A method of dispensing more than one frozen drinks simultaneously, the method comprising:
dispensing a precise quantity of a flavored fluid from a variety of flavored fluids into a first blender cup from a dispensing station of a frozen drink dispenser;
dispensing a precise quantity of shaved ice into a second blender cup and mixing contents in the second blender cup in a shaved ice and blend station of the dispenser; and
rinsing a third blender cup in a rinse station of the dispenser,
wherein dispensing flavored fluid, dispensing and mixing shaved ice, and rinsing occur substantially simultaneously.

16. The method of claim 15, further comprising weighing the first blender cup after dispensing the precise quantity of the flavored fluid into the first blender cup.

17. The method of claim 15, further comprising blending the contents of the second blender cup with blades provided in the second blender cup.

18. The method of claim 15, further comprising draining excess from the shaved ice and blend station and the rinse station in a common drain that extends from the rinse station to the shaved ice and blend station.

19. The method of claim 15, further comprising controlling the operation of the dispenser with a controller and displaying user operational commands on a display.
